(19) United States
(12) Patent Application Publication
(10) Pub. No.: US 2013/0026186 A1
(43) Pub. Date: Jan. 31, 2013

(54) Child-Resistant Fluid Dispersion Device

(71) Applicant: Walter Jenkins, Katonah, NY (US)

(72) Inventor: Walter Jenkins, Katonah, NY (US)

(21) Appl. No.: 13/264,825

(22) PCT Filed: Apr. 19, 2010
(86) PCT No.: PCT/US10/31634

§ 371 Date: Dec. 21, 2011

Related U.S. Application Data
(60) Provisional application No. 61/212,890, filed on Apr. 17, 2009.

(51) Int. Cl. B65D 83/00; B05B 11/00

(52) U.S. Cl. 222/153.13; 222/384

(57) ABSTRACT

A fluid dispersion device including a housing defining a reservoir for storing contents therein, the housing defining a plurality of detents; a cap coaxial with and rotatably coupled to the housing, the cap defining a plurality of tabs releasably engageable with the detents and a pair of depressible locator elements operable to disengage the tabs from the detents; an actuator coaxial with and longitudinally movable with respect to the housing to dispense the contents, the actuator including a nozzle extending outward beyond when the cap is in a first position, and permits movement of the nozzle when the cap is in a second position.

### CROSS-REFERENCE TO RELATED APPLICATION

This application is related to and claims priority to U.S. Provisional Patent Application Ser. No. 61/212,890, filed Apr. 17, 2009, entitled CAP-LESS, CHILD-RESISTANT CLOSURE SYSTEM FOR AIRLESS PUMPS, the entirety of which is incorporated herein by reference.

### STATEMENT REGARDING FEDERALLY SPONSORED RESEARCH OR DEVELOPMENT

n/a

### FIELD OF THE INVENTION

The present invention relates to a fluid dispersion device that prevents accidental dispersion of fluids.

### BACKGROUND OF THE INVENTION

Child or tamper resistant containers for moisture-sensitive materials are currently available in a variety of different forms and are primarily used to prevent inadvertent access by children to potentially dangerous materials such as medications, chemicals or poisons. Providing child-resistant containers, however, often adds cost, and can result in the containers being difficult for an elderly user to open. For example, many child-resistant containers typically include a rigid cap that can only be rotated and removed when a large compression force is simultaneously applied to the cap with a rotational force, presenting challenges for elderly people with weak muscles and joints.

Other child-resistant containers include a rigid cap having an arrow that must be aligned with a complementary arrow on the container. Once both arrows are aligned, a large force must be applied to the cap to snap it off the container presenting difficulties to elderly users with limited strength or dexterity.

This difficulty in opening child-resistant containers is compounded when an elderly user attempting to open the container is debilitated or has reduced manual dexterity in one or more hands as a result of, for example, arthritis. Elderly people further tend to rely on medication more than the average person, and also tend to have impaired manual strength and dexterity because of arthritis or age. Therefore, elderly people can have a more difficult time opening child-resistant containers compared to the average person. Further, many children have the requisite dexterity and strength to remove current child-resistance barriers that often require minimal intelligence to master.

Given the drawbacks of current child-resistant containers, what is needed is a child-resistant device that can be accessed with minimal force and dexterity, and is sufficiently sophisticated to prevent a child from accessing or otherwise dispensing its contents.

### SUMMARY OF THE INVENTION

The present invention advantageously provides a fluid dispersion device including a reservoir; a cap rotatable about the reservoir from a first position to a second position; and an actuator coupled to the reservoir to dispense a contents thereof, where the actuator is operable to dispense the contents when the cap is in the first position, and the actuator is not operable to dispense the contents when the cap is in the second position. The cap may include a pair of depressible locator elements, and rotation of the cap about the reservoir may require displacing the depressible locator elements. At least one of the locator elements may have a visual and/or tactile indicia element distinguishable from the cap, and the depressible locator elements may be positioned approximately 180 degrees apart from one another. The actuator may be movable in a longitudinal direction with respect to the reservoir to dispense the contents such that the cap obstructs the longitudinal movement of the actuator when the cap is in the first position. Further, the actuator may define a nozzle in fluid communication with the reservoir, and the cap, the reservoir, and/or the actuator may be coaxial with respect to one another

A fluid dispersion device is also provided, including a reservoir for storing a fluid; a cap rotatably engaged to the reservoir, the cap including a pair of depressible locator elements such that rotation of the cap about the reservoir requires displacement of the depressible locator elements; and a nozzle in fluid communication with the reservoir, the nozzle extending outward beyond a perimeter of the cap such that the cap obstructs movement of the nozzle when the cap is in a first position, and permits movement of the nozzle when the cap is in a second position. The cap may define a first guard element that abuts the nozzle when the cap is in the first position and the first guard element may be displaced from the nozzle when the cap is in the second position. The cap may define at least one tab releasably engageable with at least one detent defined by the reservoir, and displacement of the depressible locator elements may disengage the tab from the detent.

A fluid dispersion device is also provided, including a housing defining a reservoir for storing contents therein, the housing defining a plurality of detents; a cap coaxial with and rotatably coupled to the housing, the cap defining a plurality of tabs releasably engageable with the detents and a pair of depressible locator elements operable to disengage the tabs from the detents; and an actuator coaxial with and longitudinally movable with respect to the housing to dispense the contents, the actuator including a nozzle extending outward beyond a perimeter of the cap such that the cap obstructs movement of the nozzle when the cap is in a first position, and permits movement of the nozzle when the cap is in a second position.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a front cross-sectional view of an assembled embodiment of a fluid dispersion device constructed in accordance with the principles of the present invention;

FIG. 2 is a side perspective view of the reservoir shown in FIG. 1;

FIG. 3 is a another side perspective view of the reservoir shown in FIG. 2;

FIG. 4 is a top perspective view of the bottom cover shown in FIG. 1;

FIG. 5 is a top cross-sectional view of the piston shown in FIG. 1;

FIG. 6 is a top perspective view of the piston shown in FIG. 5;

FIG. 7 is a bottom perspective view of the piston shown in FIG. 5;

FIG. 8 is a side cross-sectional view of the housing shown in FIG. 1

FIG. 9 is a side cross-sectional view of the sub-stem shown in FIG. 1;

FIG. 10 is a top perspective view of the inner cap shown in FIG. 1;

FIG. 11 is a top perspective view of the outer cap shown in FIG. 1;

FIG. 12 is another top perspective view of the outer cap shown in FIG. 10;

FIG. 13 is a side perspective view of the assembled fluid dispersion device shown in FIG. 1; and

FIG. 14 is side perspective view of another fluid dispersion device of the fluid dispersion in accordance with the principles of the present invention.

### DETAILED DESCRIPTION OF THE INVENTION

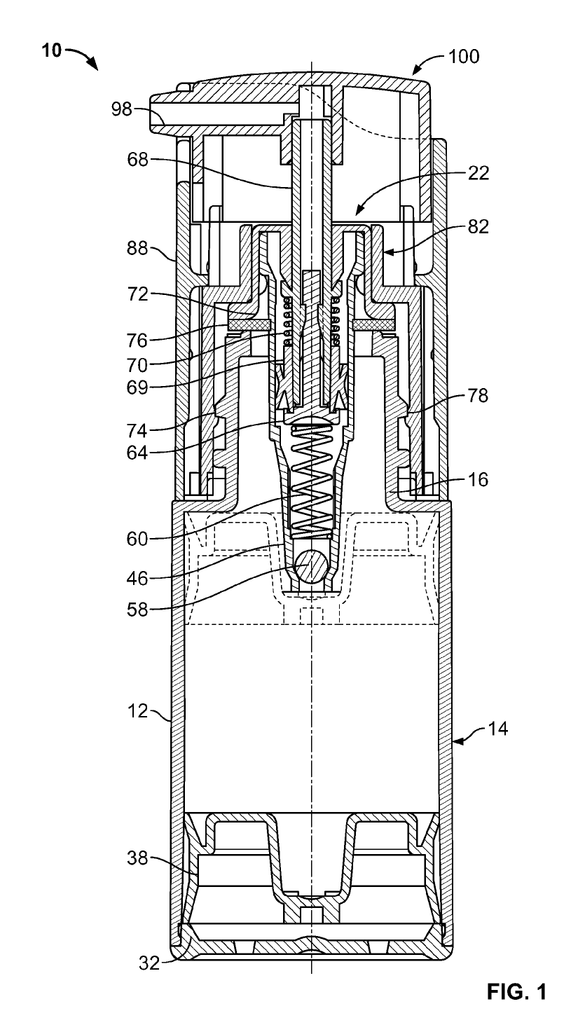

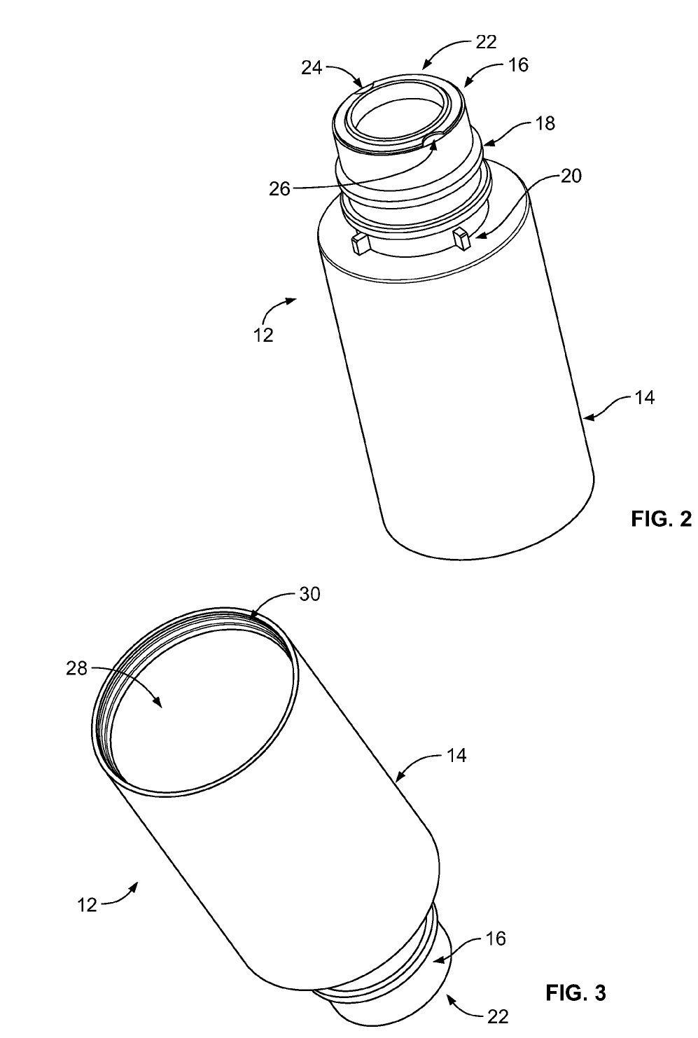

Referring now the figures in which like reference designators refer to like elements, there is shown in FIG. 1 an exemplary embodiment of a fluid dispersion device in accordance with the principles of the present invention and designated generally as “10.” The device 10 may include a reservoir 12 (shown in more detail in FIGS. 2 and 3) which may be composed of substantially rigid materials such as, for example, plastic, and may be used to house fluids, such as gels, liquids, gases, and the like. The reservoir 12 may include a hollow body portion 14 defining proximate and distal ends, and may be substantially cylindrical in shape. Of course, the shape of the illustrated reservoir is merely exemplary, as the geometric shape and dimensions may be modified or selected for use in a particular application or setting. A neck portion 16 extending from the proximate end of body portion 14 is also included, the neck portion 16 defining proximate and distal ends, and may also be substantially cylindrical in shape. For example, as shown in FIG. 2, the diameter of the body portion 14 may be larger than the diameter of the neck portion 16. In an exemplary embodiment, a medicinal ointment is stored within the reservoir 12 and may further be pressurized through the introduction or inclusion of a pressurization agent or other pressurization mechanisms as known in the art.

Referring now to FIG. 2, the neck portion 16 may include one or more annular portions 18 circumferentially disposed along its outer surface. For example, as shown in FIG. 2, two annular portions 18 are vertically spaced along the circumference of the neck portion 16. As shown in FIG. 1, the annular portions 18 may further define substantially trapezoidal or rectangular cross-sections, which may operate to facilitate the engagement of the annular portions 18 to other components of the device 10 discussed below. The neck portion 16 may further include one or more protrusions 20 positioned at the juncture between the body portion 14 and the neck portion 16. For example, as shown in FIG. 2, the protrusions 20 are positioned on the top surface of the body portion 14 at its proximal end and along the perimeter of the neck portion 16. The protrusions 20 may be substantially rectangular in shape and may be radially disposed around the neck portion 16. In an exemplary embodiment, four protrusions 20 are disposed about the neck portion 16.

The reservoir 12 may further define a first opening 22 at the proximate end of the neck portion 16. Surrounding the first opening 22 may be a lip portion 24 disposed on the inner circumference of the neck portion 16. The lip portion 24 may operate to provide a fluid-tight seal with other components of the invention. Adjacent the lip portion 24 may be one or more indentations 26. For example, as shown in FIG. 2, two indentations are disposed 180 degrees apart along the top surface of the neck portion 16. The indentations 26 may be engageable with components of the inner cap 74 (see below) to secure the inner cap 74 to the reservoir 12.

Referring now to FIG. 3, the reservoir 12 may further define a second opening 28 at the distal end of the body portion 14. The body portion 14 may further define a recess 30 circumferentially disposed along a portion of the interior surface of the distal end. For example, as shown in FIG. 3, the recess 30 is defined proximate the distal end.

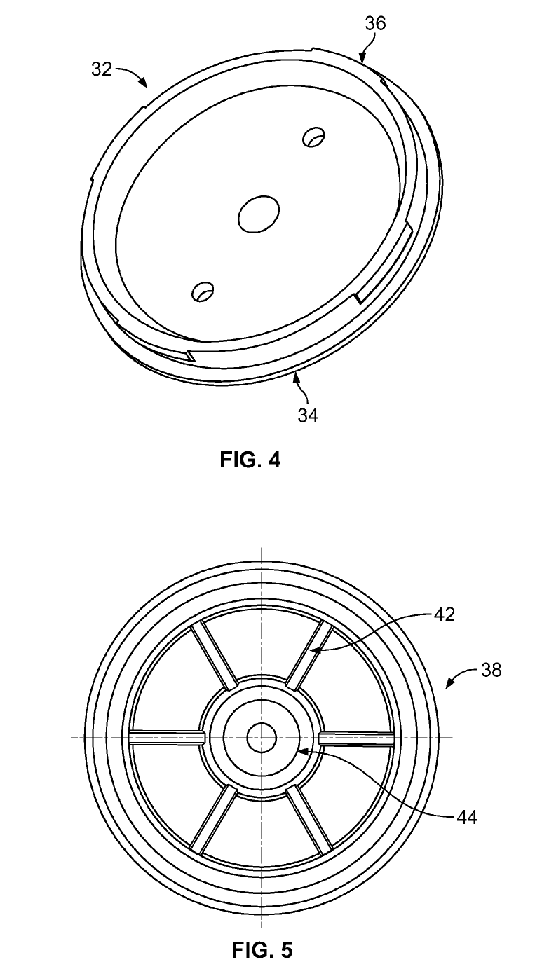

Referring now to FIG. 4, a bottom cover 32 is shown. The bottom cover 32 may be releasably engageable with the recess 30 of body portion 14. The bottom cover 32 may be substantially circular in shape and may include a flange 34 extending from the surface of the bottom cover 32. The flange 34 may further include a raised portion 36 radially extending from the flange 34. The raised portion 36 may engage and lock with the recess 30 such that the bottom cover 32 is mated to the body portion 14. For example, when applying a force to the bottom cover 32 the raised portion 36 engages and snap-fits with the recess 30.

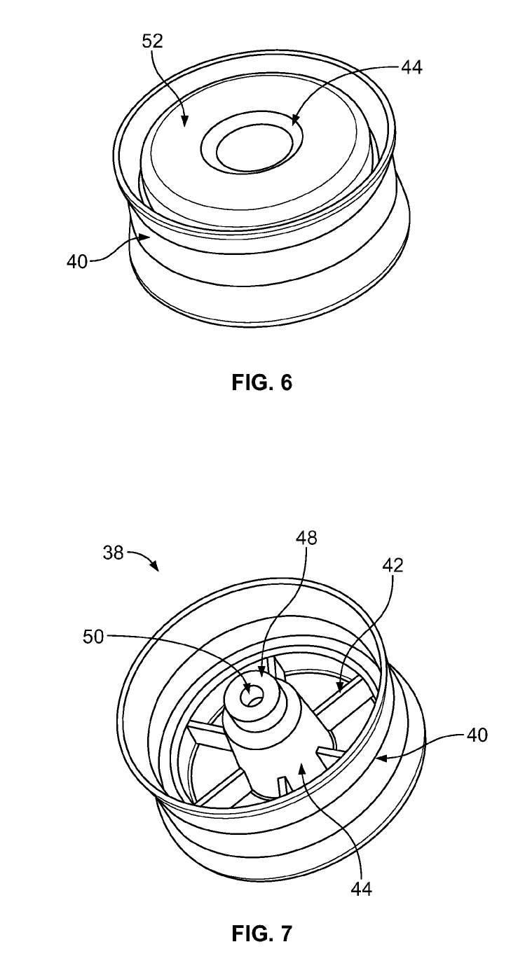

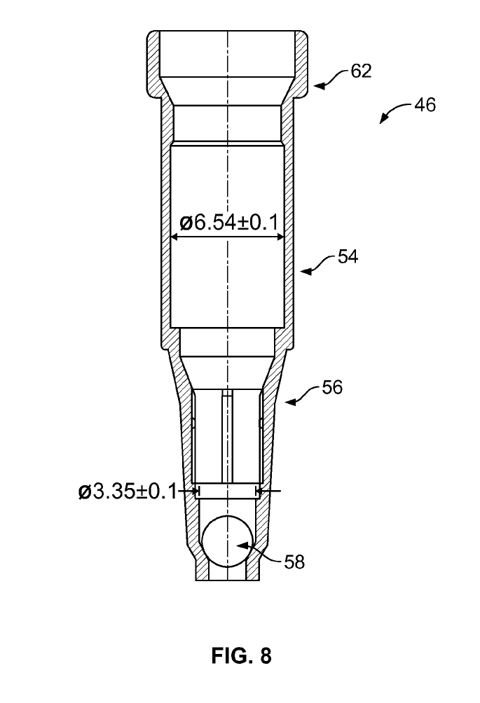

Referring now to FIGS. 5-7, a piston 38 is included with the device 10 and is movably positionable about the body portion 14 of reservoir 12 (as shown in FIG. 1). The piston 38 may be substantially disc-shaped and may optionally define a concavity 40 along a side portion thereof. This concavity 40 may facilitate the vertical movement of the piston 38 within the reservoir 12 by minimizing contact friction between the piston 38 and the inner surface of the reservoir 12. The piston 38 may further include a plurality of vanes 42 spanning from the interior surface of the piston 38 to a chasm 44 defined at the center of the piston 38. The chasm 44 defines a sufficient volume to receive a portion of a housing 46 (FIG. 8) when the contents of the reservoir 12 are fully empty, explained in more detail below. The chasm 44 may further include a tapered portion 48 at its distal end and may optionally include a pinhole 50, which may alleviate the pressure within the reservoir 12. Positioned atop the vanes 42, and surrounding the chasm 44, is a cover 52. The cover 52 may be substantially toroidal in shape, or any shape, and may be disposed within the circumference of the piston 38.

Referring now to FIG. 8, the housing 46 may be tubular in shape and include a first portion 54 and a second portion 56 and a rim portion 62, the rim portion 62 having a larger diameter than the first portion 54, and the first portion 54 having a larger diameter than the second portion 56. The housing 46 is disposable within the neck portion 16 of the reservoir 12 and within the piston 38. For example, as shown in FIG. 1, the second portion 56 is receivable within the chasm 44 and the first portion 54 is positioned in the reservoir 12 though first opening 22. The second portion 56 may be tapered and include a ball 58 sized to fit within the second portion 56. The ball 58, which is spherical in shape, is longitudinally movable within the second portion 56 in response to changes in pressure facilitated by actuation of device 10, discussed in more detail below. Also disposed within the second portion 56 is spring element 60 (FIG. 1). The spring element 60 provides resistance to the movement of ball 58 within the second portion 56.

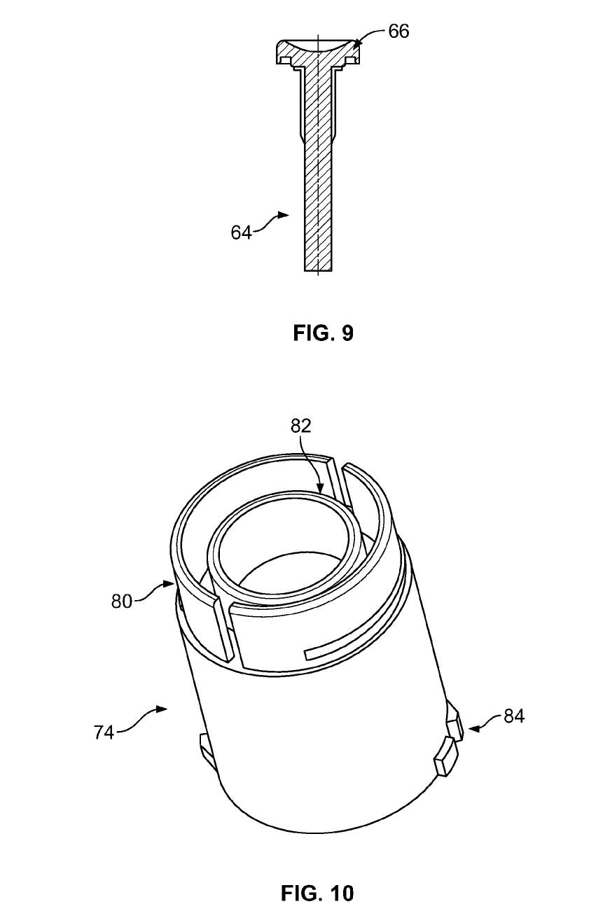

Referring now to FIG. 9, also positionable within the housing 46 is sub-stem 64 (seen disposed within the housing 46 in FIG. 1). The sub-stem 64 evacuates the housing 46 when the device 10 is actuated at which point a new dose is drawn up from the reservoir 12 into the housing 46. The sub-stem 64 may define a flared end section 66 that is operable to apply a force to the spring element 60 when the device is actuated. The sub-stem 64 may further be disposed within a stem 68 (FIG. 1) that is in fluid communication with the contents of reservoir 12 and with the ambient environment when the device 10 is actuated. The stem 68 is also a tube through which the contents of reservoir 12 flow. Optionally, a small piston 69 may be provided within the housing 46 adjacent the stem 68 to facilitate the movement of the stem 68 and sub-stem 64 within the housing 46. The movement of the small piston 69 may be restricted by a short spring 70, which may be buttressed between the rim portion 62 of housing 46 and the small piston 69. Similar to the operation of spring element 60, the short spring 70 resists the movement of the small piston 69 within the housing 46.

Adjacent to the housing 46 is a chaplet 72 (FIG. 1). The chaplet 70 is operable to bridge the gap between the housing 46, the reservoir 12, and an inner cap 74 shown in FIG. 10. The chaplet 72 may be substantially L-shaped and may further be molded directly on the housing 46 or the neck portion 16 of the reservoir 12. In order to provide a fluidly tight seal between the reservoir 12 and the chaplet 72, one or more gaskets 76, which may be composed of rubber or similar material, may be sandwiched between the chaplet 72 and the neck portion 16 of the reservoir 12. The gaskets 76 may be flexible and bend in response to movement of the stem 68 within the housing 46. For example, the gaskets 76 may be positioned such that the contents of the reservoir 12 may flow through the housing 46 to egress from the device 10.

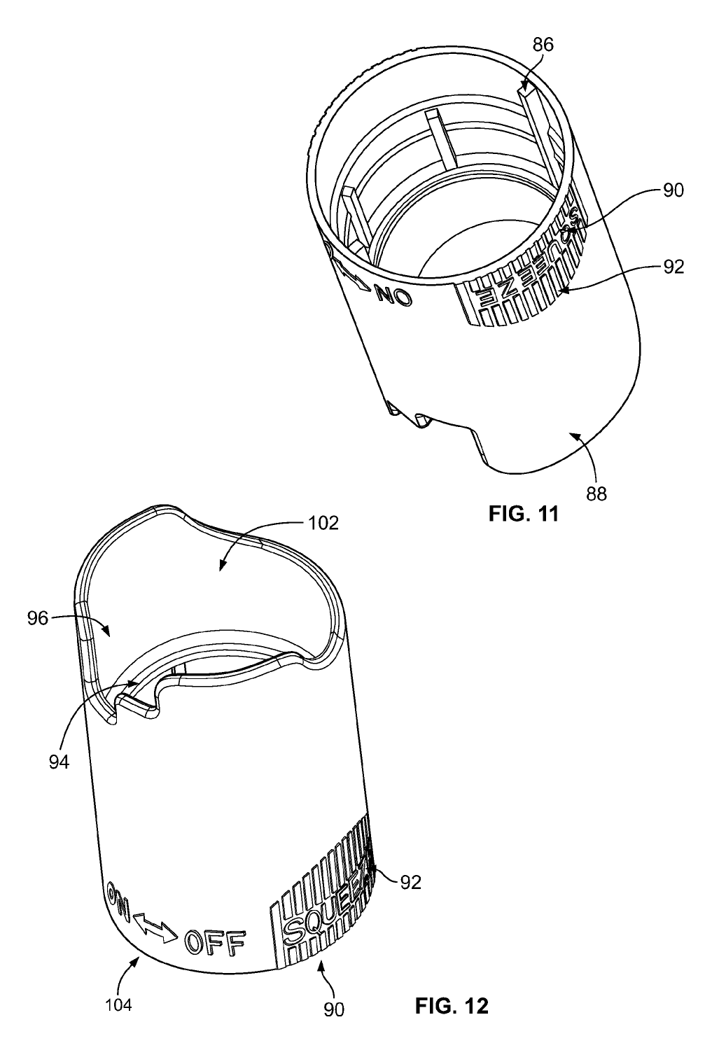

Referring now to FIG. 10, where the inner cap 74 is shown. The inner cap 74 may be substantially cylindrical in shape and hollow. Disposed within the inner cap 74 are radial extensions 78 (shown in FIG. 1) that engage annular portions 18 on the neck portion 16 of reservoir 12 to secure the inner cap 74 to the reservoir 12. The inner cap 74 is also engageable with the protrusions 20 on the neck portion of the container 12. The inner cap 74 also includes spilt curves 80 that surround an actuator support element 82 and defines a channel 83 between them. The actuator support element 82 may define a substantially circular cross-section and may engage with the chaplet 72. A pair of detents 84 may be included on the surface of the inner cap 74, the detents 84 being sized to receive and engage tabs 86 (FIG. 11) disposed on the interior portion of an outer cap 88.

Referring now to FIGS. 11-12, where the outer cap 88 is shown. The outer cap 88 may be substantially cylindrical, hollow, and coaxial with the reservoir 12. The outer cap 88 may include a pair of tabs 86 on its interior surface. The pair of tabs 86 engages the pair of detents 84 on the inner cap 74 to secure the outer cap 88 to the inner cap 74. Spaced approximately 90 degrees apart from the pair tabs 86 are two locator elements 90 disposed on the exterior surface of the outer cap 88. In other embodiments, the locator elements 90 may be spaced any distance apart from each other. The locator elements 90 may be any size or shape and further have one or more indicia elements 92 that visually or tactilely distinguish the locator elements 90 from the remainder of the exterior surface of the outer cap 88. For example, the locator elements 90 may include visual indicia elements 92, such as the word “SQUEEZE,” or tactile indicia elements 92 such as a raised or striated surface. Further, an application of an internal radial force, for example by pressing, squeezing, or pinching both locator elements 90, causes an outward flexion of the outer cap 88 at positions approximately 90 degrees away from the locator elements 90. This outward flexion allows the pair of tabs 86 to disengage from the pair of detents 84, which allows the outer cap 88 to rotate about the inner cap 74 while both locator elements 90 are pressed. Absent a simultaneous application of an internal force to both locator elements 90, the outer cap 88 is not rotatable about the inner cap 74 and/or the reservoir 12, as the tabs 86 remain locked into detents 84.

Continuing to refer to FIGS. 11-12, the outer cap 88 may define a first guard element 94 and a second guard element 96 along the perimeter of its top surface. The first guard element 94 is operable to prohibit rotational movement of the outer cap 88 about the inner cap 74 and the reservoir 12. The device 10 further includes a nozzle 98 and an actuator 100 disposable within the outer cap 88 and within the channel 83 defined by the inner cap 74 (as seen in FIG. 10). The actuator 100 may be, for example, a depressable plunger or pump with the nozzle 98 extending outward from the actuator and from the perimeter of the outer cap 88. The nozzle 98 may be substantially cylindrical in shape and may be in fluid communication with the contents of the reservoir 12. The nozzle 98 may further define a narrow passageway that is tapered towards its distal end to accelerate the contents of the reservoir 12 as the contents expelled. The diameter of the tapered distal end portion of the nozzle 98 may further be variable depending on the desired spray pattern of the contents. For example, a small diameter may be defined to create a fine mist and larger diameter may be defined to create a stream.

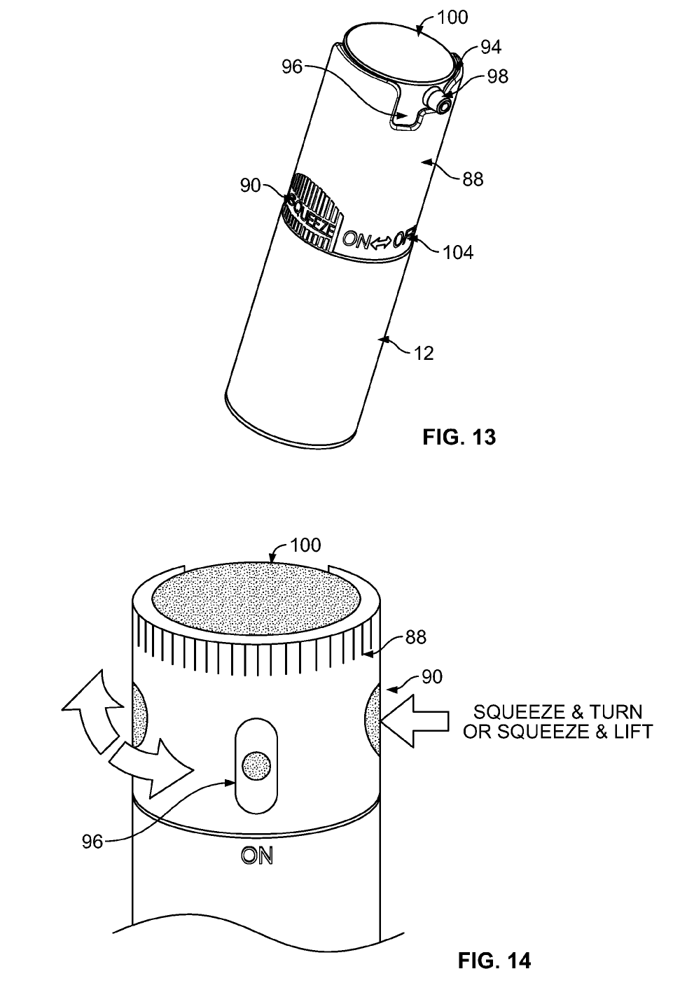

As shown in FIG. 13, in an exemplary embodiment, the nozzle 98 is disposed within the first guard element 94 at a first position, the first guard element 94 being shaped to prevent both clockwise movement of the outer cap 88 about the inner cap 74 and the reservoir 12, regardless of whether the locater elements 90 are pressed, and to prevent the actuator 100 from being depressed. Upon application of an internal radial force to both locator elements 90, which releases tabs 86 from detents 84, the outer cap 88 may be rotated counter-clockwise about the inner cap 74 and the reservoir 12 to a second position, wherein the nozzle 98 is disposed within the second guard element 96. In the second position, the outer cap 88 is prohibited from rotating counter-clockwise, regardless of whether the locater elements 90 are pressed, but the second guard element 96 is shaped to allow the actuator 100 to be depressed, thereby releasing the contents of the reservoir 12. The second guard element 96 further restricts the maximum distance the actuator 100 may be depressed, such that each full pump of the actuator 100 releases the same volume of contents from the reservoir 12. These features may operate to prevent accidental use of the device 10 by children, while also making the device 10 easy to use by elderly people as minimal force and dexterity are required to use the device 10.

It is further contemplated that in other embodiments that position of the first and second guard elements 94, 96 may be switched such that the outer cap 88 can rotate about the inner cap 74 in the opposite direction. Alternatively, in lieu of applying pressure, i.e squeezing the locator elements 90 to release the tabs 86 from the detents 84, that the tabs 86 can be released from the detents 84 by an application of a downward force onto both locator elements 90. Alternatively, as shown in FIG. 14, the nozzle 96 may be disposable within the outer cap 88 such that rotation or lowering of the outer cap 88 about the inner cap 74, by pinching the locator elements 90, conceals nozzle 96 and prevents the actuator 100 from being depressed. As the outer cap 88 is rotated in the opposite direction, or as the outer cap 88 is raised, the nozzle 96 is exposed, which allows the contents of the reservoir 12 to be expelled.

Referring back now to FIGS. 11 and 12, the outer cap 88 may further define a sloped portion 102 that reveals a portion of the actuator 100. For example, a few millimeters of the actuator 10 may be exposed when viewed through the sloped portion 102. The sloped portion 102 may facilitate the depression of the actuator 100 by reducing the height of the perimeter of the outer cap 88, which makes it easier for a user to depress the actuator 102. The outer cap 88 may further include instructional elements 104, for example, an “ON⇄OFF” direction text disposed on its surface to indicate the required directions to actuate the device 10 or to lock it in a position where it cannot be actuated.

In an exemplary method of operation of device 10, the outer cap 88 is positioned in the first position described above. Because the nozzle 98 extends outward beyond the perimeter of the outer cap 88, the outer cap 88 is prohibited from rotating, owing to both the tabs 86 being engaged with the detents 84 and to the nozzle 98 blocking the outer cap 88 from rotating. A user then identifies the position of the locator elements 90, by either feeling them (if for example the ambient lighting is poor) or seeing them, and squeezes both locator elements 90 and rotating the outer cap 88 from the first position to the second position described above. When the outer cap 88 is in the second position, the tabs 86 engage another portion of the detents 84, which secures the outer cap 88 in the second position. If the user is operating the device 10 for the first time, the user may need to prime the device 10 by depressing on the actuator 100 a few times, for example 10, to build up sufficient pressure in the device 10 to expel the contents of the reservoir 12. Alternatively, no priming may be necessary. Once the device 10 is primed, the user depresses the actuator 100 to expel a dose of contents from the reservoir 12.

For example, each full pump of the actuator 100 may release approximately a 0.05 ml dose from contents in reservoir 12. As the actuator 100 plunges into the outer cap 88, it also forces the stem 68 into the housing 46 and causes a measured or metered portion of the contents of the reservoir 12 to be expelled from the device 10. The characteristics and/or dimensions of the components of the device 10 may be selected or defined such that a single, full depression of the actuator results in a predetermined amount or volume of medicament or other fluid being dispelled from the reservoir. As the stem 68 is forced into the housing 46, the spring element 60 provides a counter-force, which slows stem 68′s movement into the housing 46, and then forces the stem 68 out of the housing 46 when the user releases the actuator 100. As the actuator 100 begins to rise, a dose of contents from the reservoir 12 is drawn into the housing 46 owing the back pressure exerted by the contents, which are placed under pressure prior to using the device 10. As the contents of the reservoir 12 are directed towards the housing 46, the ball 58 will rise a short distance against gravity allowing a portion of the contents to enter the housing 46. After a portion of contents enters the housing 46, the gravity's push on the ball 58 will exceed the pressure that forces the contents into the housing 46, and forces the ball 58 down into a position that prevents further contents from entering the housing 46. Also, after each pump that releases contents of the reservoir 12 from the device 10, the piston 38 will rise a distance to reflect the loss in pressure from the reservoir 12. For example, as shown in FIG. 1, after all the contents of the reservoir 12 are released, the piston 38 rises to a position such that the housing 46 is positioned within the chasm 44, which prevents the actuator element 100 from being pressed.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A fluid dispersion device, comprising:
a reservoir;
a cap rotatable about the reservoir from a first position to a second position; and
an actuator coupled to the reservoir to dispense a contents thereof, wherein the actuator is operable to dispense the contents when the cap is in the first position, and the actuator is not operable to dispense the contents when the cap is in the second position.

2. The fluid dispersion device of claim 1, wherein the cap includes a pair of depressible locator elements, and wherein rotation of the cap about the reservoir requires displacing the depressible locator elements.

3. The fluid dispersion device of claim 2, wherein at least one of the locator elements has a visual indicia element distinguishable from the cap.

4. The fluid dispersion device of claim 2, wherein at least one of the locator elements has a tactile indicia element distinguishable from the cap.

5. The fluid dispersion device of claim 2, wherein the depressible locator elements are positioned approximately 180 degrees apart from one another.

6. The fluid dispersion device of claim 1, wherein the actuator is movable in a longitudinal direction with respect to the reservoir to dispense the contents, and wherein the cap obstructs the longitudinal movement of the actuator when the cap is in the first position.

7. The fluid dispersion device of claim 1, wherein the actuator defines a nozzle in fluid communication with the reservoir.

8. The fluid dispersion device of claim 1, where in the cap and the reservoir are coaxial with respect to each other.

9. The fluid dispersion device of claim 6, where the actuator and the reservoir are coaxial with respect to each other.

10. A fluid dispersion device, comprising:
a reservoir for storing a fluid;
a cap rotatably engaged to the reservoir, the cap including a pair of depressible locator elements such that rotation of the cap about the reservoir requires displacement of the depressible locator elements; and
a nozzle in fluid communication with the reservoir, the nozzle extending outward beyond a perimeter of the cap such that the cap obstructs movement of the nozzle when the cap is in a first position, and permits movement of the nozzle when the cap is in a second position.

11. The fluid dispersion device of claim 10, wherein the cap defines a first guard element that abuts the nozzle when the cap is in the first position.

12. The fluid dispersion device of claim 11, wherein the first guard element is displaced from the nozzle when the cap is in the second position.

13. The fluid dispersion device of claim 10, wherein the cap defines at least one tab releasably engageable with at least one detent defined by the reservoir, and wherein displacement of the depressible locator elements disengages the tab from the detent.

14. The fluid dispersion device of claim 10, wherein at least one of the locator elements has a visual indicia element distinguishable from the cap.

15. The fluid dispersion device of claim 10, wherein the locator elements are spaced approximately 180 degrees apart on the surface of the cap.

16. The fluid dispersion device of claim 10, wherein the nozzle is longitudinally movable with respect to the reservoir to dispense the fluid.

17. A fluid dispersion device, comprising
a housing defining a reservoir for storing contents therein, the housing defining a plurality of detents;
a cap coaxial with and rotatably coupled to the housing, the cap defining a plurality of tabs releasably engageable with the detents and a pair of depressible locator elements operable to disengage the tabs from the detents; and
an actuator coaxial with and longitudinally movable with respect to the housing to dispense the contents, the actuator including a nozzle extending outward beyond a perimeter of the cap such that the cap obstructs movement of the nozzle when the cap is in a first position, and permits movement of the nozzle when the cap is in a second position.

18. The fluid dispersion device of claim 17, wherein the cap defines a first guard element that abuts the nozzle when the cap is in the first position.

19. The fluid dispersion device of claim 17, wherein each locator element includes both a visual indicia element and a tactile indicia element distinguishable from the cap.

20. The fluid dispersion device of claim 17, wherein the locator elements are spaced approximately 180 degrees apart on the surface of the cap.
